(19) United States
(12) Patent Application Publication
(10) Pub. No.: US 2008/0128947 A1
(43) Pub. Date: Jun. 5, 2008

(54) Tire manufacturing method

(75) Inventor: Masayuki Sakamoto, Kobe-shi (JP)

Correspondence Address: BIRCH STEWART KOLASCH & BIRCH, PO BOX 747, FALLS CHURCH, VA, 22040-0747, US

(73) Assignee: Sumitomo Rubber Industries, Ltd

(21) Appl. No.: 11/976,829

(22) Filed: Oct. 29, 2007

(30) Foreign Application Priority Data
Dec. 1, 2006 (JP) 2006-325423

(51) Int. Cl. B60C 5/00; B29C 35/00

(52) U.S. Cl. 264/326; 152/450

(57) ABSTRACT

A green tire (20) is put into a mold (16) in which an insert core (18) and a bladder (22) are accommodated. In the putting operation, a diameter of the insert core (18) is reduced and the bladder (22) is contracted. After the putting operation, the diameter of the insert core (18) is increased so that an inner surface of a bead (8) of the green time (20) abuts on an insert core plate (36). The bead is interposed between the insert core (18) and a cavity surface (34). By filling a gas, the bladder (22) is gradually expanded. The mold (16) is clamped so that an internal pressure of the bladder (22) is further raised. A portion of an inner peripheral surface of the green tire (20) which does not abut on the insert core (18) abuts on the bladder (22). The green tire (20) is heated by a thermal conduction from the mold (16) and the bladder (22).

This application claims priority on Patent Application No. 2006-325423 filed in JAPAN on Dec. 1, 2006, the entire contents of which are hereby incorporated by reference.

### BACKGROUND OF THE INVENTION

1. Field of the Invention

The present invention relates to a method of manufacturing a tire. More particularly, the present invention relates to an improvement in a step of vulcanizing a tire.

2. Description of the Related Art

In a step of vulcanizing a pneumatic tire, a mold and a bladder are used. The mold is formed of a metal. The bladder is formed of a rubber. The bladder is accommodated in the mold. At the vulcanizing step, a green tire obtained in a preforming step is put into the opened mold. In the putting operation, the bladder is contracted. By the putting operation, the bladder is positioned on an inside of the green tire. The bladder is expanded by filling a gas. By the expansion, the green tire is deformed. The deformation is referred to as shaping. Next, the mold is clamped so that an internal pressure of the bladder is raised. The green tire is interposed between a cavity surface of the mold and an outer surface of the bladder and is thus pressurized. The green tire is heated by a thermal conduction from the mold and the bladder. By the pressurization and the heating, a rubber composition of the green tire flows. By the flow, air in the mold is moved and discharged from the mold. By the heating, the rubber causes a crosslinking reaction so that a tire is obtained. A method of manufacturing a tire using a bladder has been disclosed in Japanese Laid-Open Patent Publication No. 6-143288.

A shape of an inner surface of the tire depends on a shape of the bladder in the expansion. Since the bladder is formed of a rubber, precision in a shape in the expansion is not sufficient. When the bladder is repetitively used, furthermore, the shape in the expansion fluctuates by a variation with time of physical properties and a thickness. A shape of the inner surface of the tire cannot be controlled easily.

In an expanding process, the bladder gradually abuts on an inner peripheral surface of the green tire. In some cases, the rubber composition of the green tire causes an unintended flow by the abutment. Due to the flow, a shape of a carcass is shifted from a designed shape in some cases. When the shape of the bladder is nonuniform, furthermore, a uniformity of the tire is impeded.

In some cases, a metallic insert core is used in place of the bladder. The insert core is hard and is excellent in precision in a dimension. Furthermore, the dimension does not fluctuate in the insert core. By the insert core, it is possible to obtain a tire which is excellent in the precision in a dimension.

In a manufacturing method using an insert core, it is necessary to prepare an insert core having a suitable size for each size of the tire. The insert core is generally expensive. A high cost is required for manufacturing a tire using the insert core.

Differently from the bladder, the insert core is not expanded. A distance between the cavity surface of the mold and the insert core is constant. In other words, the green tire is not pressurized by the insert core. At a vulcanizing step using the insert core, a pressure applied to the green tire depends on only a thermal expansion of the green tire. The pressure is not sufficient. In a region of the green tire in which a thickness is small, particularly, the pressure becomes insufficient due to a small amount of expansion. The insufficiency of the pressure causes air to remain. Due to the insufficiency of the pressure, rubber members constituting the green time cannot be sufficiently bonded to each other in some cases.

It is an object of the present invention to provide a manufacturing method by which a tire of high quality can be obtained at a low cost.

### SUMMARY OF THE INVENTION

A method of manufacturing a tire according to the present invention comprises the steps of:

(1) forming a green tire including a tread, a sidewall and a bead;

(2) putting the green tire into a mold; and

(3) heating the green tire in a state in which an outer surface of the green tire abuts on a cavity surface of the mold, a whole or part of an inner surface of the bead abuts on a hard insert core accommodated in the mold, and a portion of an inner peripheral surface of the green tire which does not abut on the insert core abuts on a soft bladder accommodated in the mold.

A shape of the bead influences various performances of the tire. The shape of the bead is important. In the present invention, the bead is vulcanized and formed with an interposition between the mold and the insert core. Therefore, the shape of the bead is coincident with a designed shape. In the present invention, the portion of the inner peripheral surface of the green tire which does not abut on the insert core is pressurized by the bladder. An applied pressure is high. The insert core to be used in the present invention can be obtained at a low cost. The insert core is excellent in a versatility. By the present invention, a tire of high quality can be obtained at a low cost.

It is preferable that a tip of the insert core should be positioned between an upper surface of a core of the bead and a maximum width point of a tire in a radial direction. It is preferable that a diameter of the insert core can be reduced and increased. It is preferable that an expanded bladder can abut on an inside of the insert core.

### BRIEF DESCRIPTION OF THE DRAWINGS

FIG. 1 is a sectional view showing an example of a tire obtained by a manufacturing method according to the present invention,

FIG. 2 is a plan view showing a part of a mold to be used for manufacturing the tire illustrated in FIG. 1,

FIG. 3 is an enlarged sectional view taken along a III-III line in FIG. 2, and

FIG. 4 is an enlarged sectional view showing a part of the mold in FIG. 3.

### DESCRIPTION OF THE PREFERRED EMBODIMENTS

The present invention will be described below in detail based on a preferred embodiment with reference to the drawings.

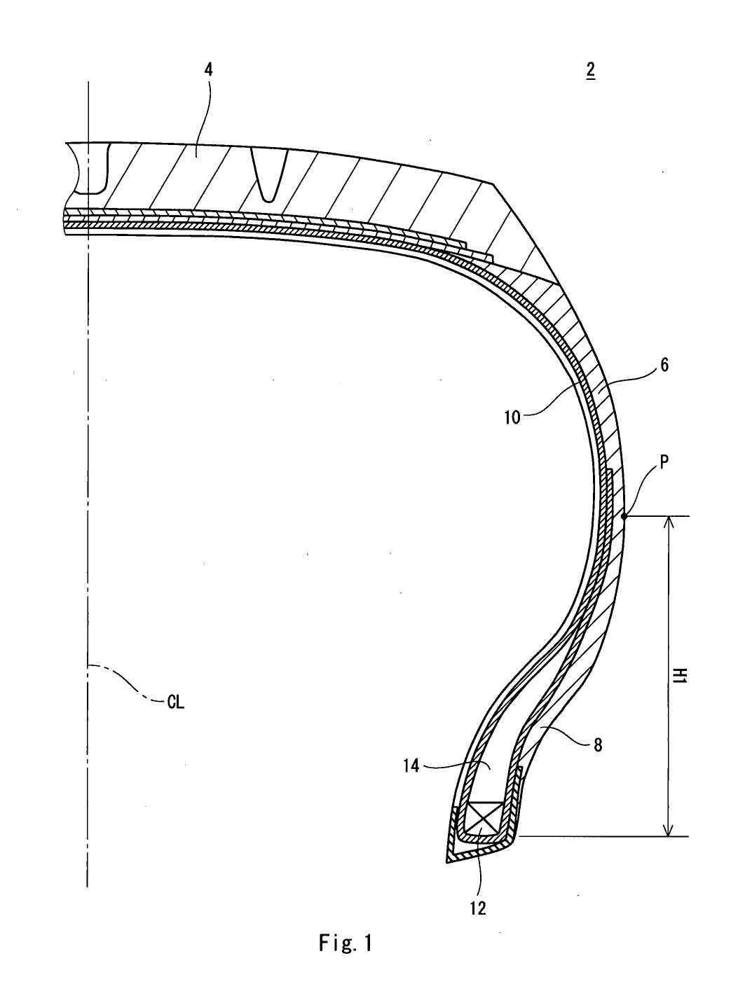

In FIG. 1, a vertical direction is set to be a radial direction, a transverse direction is set to be an axial direction, and a perpendicular direction to a paper is set to be a circumferential direction. A tire 2 shown in FIG. 1 takes an almost symmetrical shape about a one-dotted chain line CL in FIG. 1. The one-dotted chain line CL represents an equator plane of the tire 2. The tire 2 comprises a tread 4, a pair of sidewalls 6, and a pair of beads 8. The tread 4 takes an outward convex shape in the radial direction. The tread 4 comes in contact with a road surface. The sidewall 6 is extended almost inward in the radial direction from an end of the tread 4. The bead 8 is extended almost inward in the radial direction from the sidewall 6. The tire 2 comprises a carcass 10. The carcass 10 is present over the tread 4, the sidewall 6 and the bead 8.

The bead 8 includes a core 12 and an apex 14 extended outward in the radial direction from the core 12. The core 12 is ring-shaped. The core 12 includes a plurality of non-extensible wires (typically wires formed of steel). The apex 14 is outward tapered in the radial direction. The apex 14 is formed by a crosslinked rubber having a high hardness.

A maximum width point is indicated as P in FIG. 1. The maximum width point P is placed on an outermost side in an axial direction excluding a clinch portion. A double arrow H1 indicates a height from a bead baseline BL to the maximum width point P. The height H1 is measured in the radial direction.

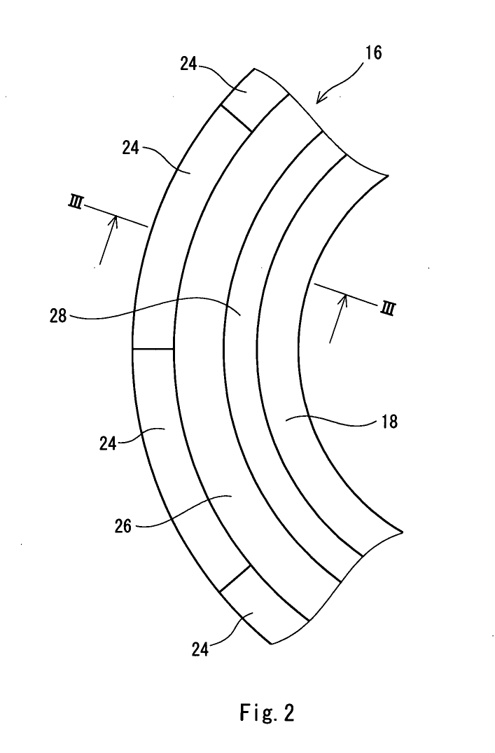

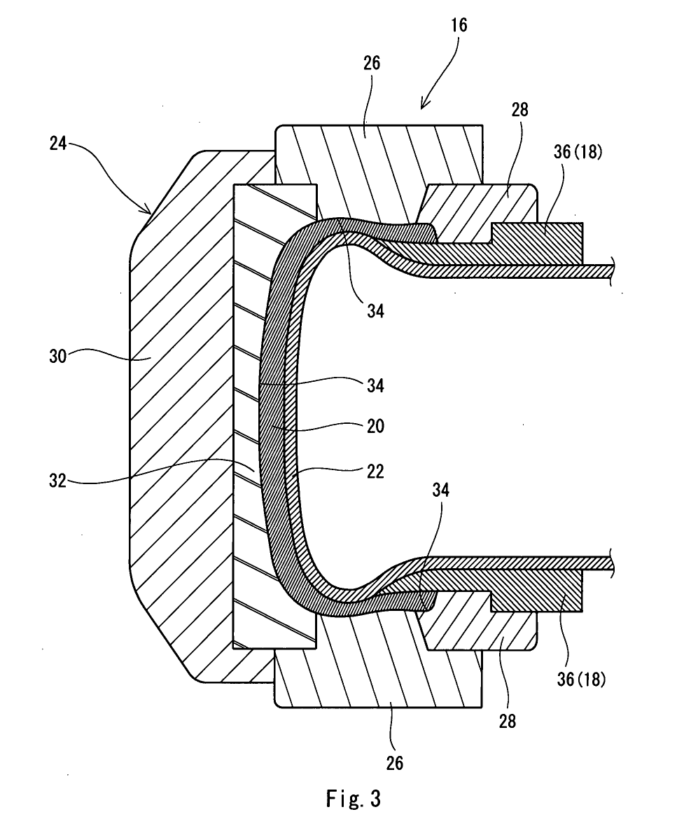

FIG. 2 is a plan view showing a part of a mold 16 to be used for manufacturing the tire 2 in FIG. 1. In FIG. 2, an insert core 18 is also shown together with the mold 16. FIG. 3 is an enlarged sectional view taken along a III-III line in FIG. 2. In FIG. 3, a green tire 20 and a bladder 22 are also shown together with the mold 16 and the insert core 18.

The mold 16 includes a large number of tread segments 24, a pair of upper and lower side plates 26, and a pair of upper and lower bead rings 28. The segment 24, the side plate 26 and the bead ring 28 are formed by metallic materials. A planar shape of the segment 24 is a substantially circular arc. The segment 24 is constituted by a holder 30 and a plurality of pieces 32. A large number of segments 24 are coupled like a ring. The number of the segments 24 is usually equal to or larger than 3 and is equal to or smaller than 20. The side plate 26 and the bead ring 28 are substantially ring-shaped. The mold 16 is a so-called “two phase mold”. A cavity surface 34 is formed by the segment 24, the side plate 26 and the bead ring 28.

The insert core 18 includes a pair of insert core plates 36. The insert core plate 36 is substantially ring-shaped. As is apparent from FIG. 3, the insert core plate 36 is positioned on an inside of the bead ring 28. A part of the green tire 20 is present between the bead ring 28 and the insert core plate 36. A part of the green tire 20 is also present between the side plate 26 and the insert core plate 36. The insert core plate 36 is formed by a metallic material. The insert core plate 36 is divided into a plurality of members in a circumferential direction, which is not shown. By the division, a diameter of the insert core 18 can be reduced.

The bladder 22 is formed by a crosslinked rubber. The bladder 22 is hollow. By filling the bladder 22 with a gas, the bladder 22 can be expanded. By releasing the gas from the bladder 22, the bladder 22 can be contracted. FIG. 3 shows the bladder 22 in an expanding state. The bladder 22 is provided along an inside of the insert core plate 36. The bladder 22 is further provided along the green tire 20.

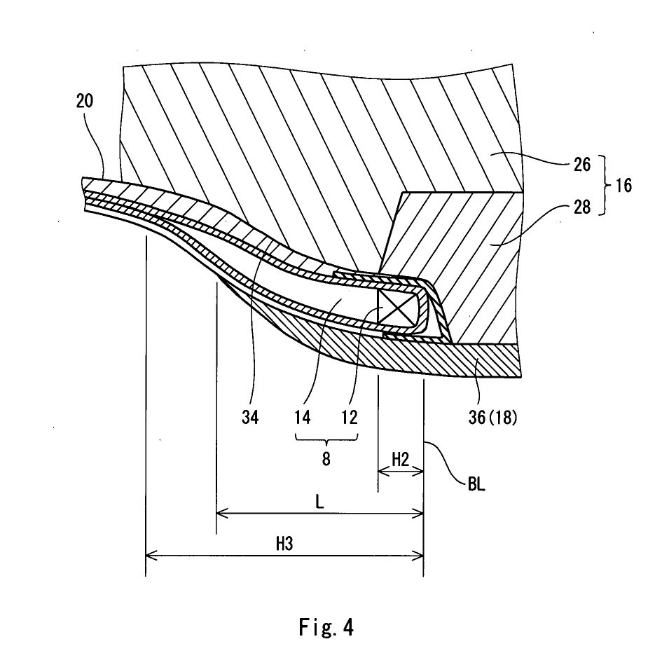

FIG. 4 is an enlarged sectional view showing a part of the mold 16 in FIG. 3. In FIG. 4, the green tire 20 and the insert core plate 36 are also shown. In FIG. 4, the bladder 22 is not shown. As is apparent from FIG. 4, an outer surface of the bead 8 abuts on the cavity surface 34 formed by the side plate 26 and the bead ring 28. A part of an inner surface of the bead 8 abuts on the insert core plate 36. The bead 8 is interposed between the mold 16 and the insert core 18.

At a vulcanizing step using the mold 16, the green tire 20 is put into the mold 16 in which the insert core 18 and the bladder 22 are accommodated. In the putting operation, the diameter of the insert core 18 is reduced and the bladder 22 is contracted. By the putting operation, the insert core 18 and the bladder 22 are positioned on an inside of the green tire 20. When the diameter of the insert core 18 is increased after the putting operation, the inner surface of the bead 8 abuts on the insert core plate 36. When a gas is filled, the bladder 22 is gradually expanded. The bladder 22 is first provided along the insert core plate 36. The bladder 22 is further expanded and is thus provided along the inner surface of the green tire 20. The mold 16 is clamped so that an internal pressure of the bladder 22 is raised. FIG. 3 shows a state in which the bladder 22 is expanded most greatly. The green tire 20 is heated by a thermal conduction from the mold 16 and the bladder 22. By the pressurization and the heating, a rubber composition of the green tire 20 flows. By the flow, air in the mold 16 is moved and discharged from the mold 16. By the heating, the rubber causes a crosslinking reaction so that the tire 2 is obtained.

At the vulcanizing step, the outer surface of the green tire 20 abuts on the cavity surface 34 of the mold 16. Furthermore, the inner surface of the bead 8 abuts on the insert core plate 36. In other words, the bead 8 is interposed between two hard members and is thus heated. In the tire 2 obtained by the manufacturing method, precision in the dimension of the bead 8 is high. By the manufacturing method, it is possible to obtain the tire 2 comprising the bead 8 having a shape which is not shifted from a designed shape.

When the tire 2 is incorporated into a rim, the bead 8 is fitted in the rim. Referring to the tire 2 obtained by the manufacturing method according to the present invention, the bead 8 takes a proper shape. Therefore, the bead 8 abuts on the rim in a proper state. Accordingly, the air filled in the tire 2 does not leak out of a portion between the bead 8 and the rim. The shape of the bead 8 influences a flexure of the tire 2. In the tire 2, a proper flexure is obtained. When the tire 2 is incorporated into the rim, a proper fitting pressure is generated. The bead 8 of the tire 2 is not shifted from the rim in a sudden acceleration and a sudden deceleration of a vehicle. By the tire 2, a wheel balance can be maintained. In the tire 2, a dimension of the bead 8 has a small variation in the circumferential direction. The tire 2 is excellent in a uniformity.

As is apparent from FIG. 3, a portion of the inner peripheral surface of the green tire 20 which does not abut on the insert core 18 abuts on the bladder 22. By the bladder 22, the green tire 20 is sufficiently pressurized. By the pressurization, the rubber composition fully flows so that the air is discharged. By the pressurization, rubber members constituting the green tire 20 are reliably bonded to each other. By the manufacturing method using the insert core 18 and the bladder 22 in combination, it is possible to obtain the tire 2 of high quality.

The insert core 18 is more inexpensive than a conventional insert core which abuts on the whole inner surface of the green tire 20. Furthermore, the insert core 18 can be used for manufacturing a plurality of tires 2 in which the bead 8 has an identical shape and a plurality of different sizes. The insert core 18 has a high versatility. By using the insert core 18, it is possible to obtain the tire 2 at a low cost.

In the manufacturing method, the shape of the insert core plate 36 is devised. Consequently, it is possible to form the bead 8 taking an optional shape without depending on the shape of the bladder 22. By the bead 8 taking a special shape, it is possible to obtain the tire 2 having a high functionality.

In FIG. 4, a double arrow L indicates a distance from the bead baseline BL to a tip of the insert core plate 36. A double arrow H2 indicates a height of an upper surface of the core 12. A double arrow H3 indicates a height of a tip of the apex 14. The heights H2 and H3 are based on the bead baseline BL. The distance L and the heights H2 and H3 are measured in the radial direction.

In respect of precision in the shape of the bead 8, it is preferable that the distance L should be greater than the height H2. More specifically, the distance L is preferably equal to or greater than 10 mm and is more preferably equal to or greater than 15 mm. In respect of the fact that the green tire 20 is sufficiently pressurized by the bladder 22 and the versatility of the insert core 18, it is preferable that the distance L should be smaller than the height H1 (see FIG. 1). More specifically, the distance L is preferably equal to or smaller than 60 mm and is more preferably equal to or smaller than 40 mm. In the insert core plate 36 shown in FIG. 4, the distance L is greater than the height H2 and is smaller than the height H3.

One of the beads 8 may be surrounded by the insert core plate 36 and the other bead 8 may be pressurized by the bladder 22. Such a manufacturing method is effective for an asymmetrical tire.

### EXAMPLES

### Example 1

A tire was manufactured by using the mold, the insert core and the bladder shown in FIGS. 2 to 4. The distance L of the insert core is 26 mm. The distance L is equal to the height H3 of the upper end of the apex. The tire has a size of “215/45ZR17”. The tire comprises a carcass ply. The carcass ply is turned up around a core. A height He of an end of a turned-up portion from the bead baseline BL is 20 mm. A height (H3−H2) of the apex in the tire is 20 mm.

### Examples 2 to 4 and 6

A tire was manufactured in the same manner as in the example 1 except that the insert core was changed. The distance L of the insert core is shown in the following Table 1. In an example 2, the distance L is smaller than the height H2. In an example 3, the distance L is equal to the height H2. In an example 4, the distance L is greater than the height H2 and is smaller than the height H3. In an example 6, the distance L is equal to the height H1.

### Example 5

A tire was manufactured in the same manner as in the example 1 except that the height He of the end of the carcass ply was set as shown in the following Table 1.

### [Evaluation of Uniformity]

RFV was measured in accordance with a condition of a uniformity test defined in “JASO C607:2000”. A mean value of results obtained by measuring 20 tires is shown in the following Table 1.

### [Sensuous Evaluation]

A tire was incorporated into a rim, and the tire and the rim were attached to a passenger car. The car is of a front engine rear wheel drive type. The car has an engine displacement of 3000 cc. The car was caused to carry out high speed running in a racing circuit and a response characteristic was rated by a driver. The result is shown in the following Table 1. A greater numeric value represents a higher evaluation.

TABLE 1
Result of evaluation

| | Comparative | | | | | | |
|---|---|---|---|---|---|---|---|
| | example 1 | Example 2 | Example 3 | Example 4 | Example 5 | Example 1 | Example 6 |
| Distance of insert core L | — | 3 | 6 | 18 | 26 | 26 | 47 |
| (mm) | | (L < H2) | (L = H2) | (H2 < L < H3) | (L = H3) | (L = H3) | (L = H1) |
| Height of end of carcass | 20 | 20 | 20 | 20 | 10 | 20 | 20 |
| ply He (mm) | | | | | | | |
| RFV (N) | 55 | 51 | 42 | 37 | 40 | 38 | 37 |
| Sensuous evaluation | 3.0 | 3.5 | 3.5 | 4.0 | 4.0 | 4.0 | 4.5 |
| Versatility of insert core | — | A | B | B | B | B | C |

As shown in the Table 1, the tires according to the examples are excellent in various performances. From the result of the evaluation, the advantages of the present invention are apparent.

The insert core can also be used in combination with a two piece mold. The above description is only illustrative and various changes can be made without departing from the scope of the present invention.

What is claimed is:

1. A method of manufacturing a tire, comprising the steps of:
(1) forming a green tire including a tread, a sidewall and a bead;
(2) putting the green tire into a mold; and
(3) heating the green tire in a state in which an outer surface of the green tire abuts on a cavity surface of the mold, a whole or part of an inner surface of the bead abuts on a hard insert core accommodated in the mold, and a portion of an inner peripheral surface of the green tire which does not abut on the insert core abuts on a soft bladder accommodated in the mold.

2. The manufacturing method according to claim.1, wherein a tip of the insert core is positioned between an upper surface of a core of the bead and a maximum width point of a tire in a radial direction.

3. The manufacturing method according to claim 1, wherein a diameter of the insert core can be reduced and increased.

4. The manufacturing method according to claim 1, wherein an expanded bladder can abut on an inside of the insert core.

5. A tire obtained by a manufacturing method comprising the steps of:
(1) forming a green tire including a tread, a sidewall and a bead;
(2) putting the green tire into a mold; and
(3) heating the green tire in a state in which an outer surface of the green tire abuts on a cavity surface of the mold, a whole or part of an inner surface of the bead abuts on a hard insert core accommodated in the mold, and a portion of an inner peripheral surface of the green tire which does not abut on the insert core abuts on a soft bladder accommodated in the mold.
